(19) United States
(12) Patent Application Publication
(10) Pub. No.: US 2007/0132834 A1
(43) Pub. Date: Jun. 14, 2007

(54) Speech disambiguation in a composite services enablement environment

(75) Inventors: William V. Da Palma, Coconut Creek, FL (US); Baiju D. Mandalia, Boca Raton, FL (US); Victor S. Moore, Lake City, FL (US); Wendi L. Nusbickel, Boca Raton, FL (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/297,593

(22) Filed: Dec. 8, 2005

(51) Int. Cl. H04N 7/14

(52) U.S. Cl. 348/14.01

(57) ABSTRACT

Embodiments of the present invention provide a method, system and computer program product for deploying and delivering composite services in an NGN network. In one embodiment, a composite service enabling data processing system can be provided. The system can include a visual channel servlet enabled to establish for a common session a visual channel of access to a composite service, and a voice channel servlet enabled to establish for the common session a voice channel of access to a composite service. The system further can include a model servlet configured for coupling to a model for the common session, for modifying state data in the model for the common session, and to synchronize views for each of the channels of access to the composite service responsive to updates detected in the model. Finally, the system can include speech disambiguation logic coupled to the voice channel servlet and can include program code enabled to utilize model updates provided over the visual channel of access when disambiguating voice input in the voice channel of access.

### BACKGROUND OF THE INVENTION

1. Field of the Invention

The present invention relates to the field of next generation networking (NGN) and more particularly to the deployment and delivery of composite services over an NGN network.

2. Description of the Related Art

Next generation networking (NGN) refers to emerging computing networking technologies that natively support data, video and voice transmissions. In contrast to the circuit switched telephone networks of days gone by, NGN networks are packet switched and combine voice and data in a single network. Generally, NGN networks are categorized by a split between call control and transport. Also, in NGN networks, all information is transmitted via packets which can be labeled according to their respective type. Accordingly, individual packets are handled differently depending upon the type indicated by a corresponding label.

The IP Multimedia Subsystem (IMS) is an open, standardized, operator friendly, NGN multimedia architecture for mobile and fixed services. IMS is a Voice over Internet Protocol (VoIP) implementation based upon a variant of the session initiation protocol (SIP), and runs over the standard Internet protocol (IP). Telecom operators in NGN networks offer network controlled multimedia services through the utilization of IMS. The aim of IMS is to provide new services to users of an NGN network in addition to currently available services. This broad aim of IMS is supported through the extensive use of underlying IP compatible protocols and corresponding IP compatible interfaces. In this way, IMS can merge the Internet with the wireless, cellular space so as to provide to cellular technologies ubiquitous access useful services deployed on the Internet.

Multimedia services can be distributed both within NGN networks and non-NGN networks, alike, through the use of markup specified documents. In the case of a service having a visual interface, visually oriented markup such as the extensible hypertext markup language (XHTML) and its many co-species can specify the visual interface for a service when rendered in a visual content browser through a visual content channel, for instance a channel governed by the hypertext transfer protocol (HTTP). By comparison, an audio interface can be specified for a service by voice oriented markup such as the voice extensible markup language (VoiceXML). In the case of an audio interface, a separate voice channel, for instance a channel governed according to SIP.

In many circumstances, it is preferred to configure services to be delivered across multiple, different channels of differing modalities, including the voice mode and the visual mode. In this regard, a service provider not always can predict the interactive modality through which a service is to be accessed by a given end user. To accommodate this uncertainty, a service can be prepared for delivery through each anticipated modality, for instance by way of voice markup and visual markup. Generating multiple different markup documents to satisfy the different modalities of access, however, can be tedious. In consequence, merging technologies such as the XHTML+VoiceXML (X+V) have been utilized to simplify the development process.

Specifically, X+V represents one technical effort to produce a multimodal application development environment. In X+V, XHTML and VoiceXML can be mixed in a single document. The XHTML portion of the document can manage visual interactions with an end user, while the VoiceXML portion of the document can manage voice interactions with the end user. In X+V, command, control and content navigation can be enabled while simultaneously rendering multimodal content. In this regard, the X+V profile specifies how to compute grammars based upon the visual hyperlinks present in a page.

Processing X+V documents, however, requires the use of a proprietary browser in the client devices utilized by end users when accessing the content. Distributing multimedia services to a wide array of end user devices, including pervasive devices across NGN networks, can be difficult if one is to assume that all end user devices are proprietarily configured to handle X+V and other unifying technologies. Rather, at best, it can only be presumed that devices within an NGN network are equipped to process visual interactions within one, standard channel of communication, and voice interactions within a second, standard channel of communication.

Thus, despite the promise of X+V, to truly support multiple modalities of interaction with services distributed about an NGN or, even a non-NGN network, different channels of communications must be established for each different modality of access. Moreover, each service must be separately specified for each different modality. Finally, once a session has been established across one modality of access to a service, one is not able to change mid-session to a different modality of access to the same service within the same session. As a result, the interactions across different channels accommodating different modalities of interaction remain unsynchronized and separate. Consequently, end users cannot freely switch between modalities of access for services in an NGN network.

### BRIEF SUMMARY OF THE INVENTION

Embodiments of the present invention address deficiencies of the art in respect to deploying and delivering a service to be accessed through different channels of access in an NGN network, and provide a novel and non-obvious method, system and apparatus for deploying and delivering composite services in an NGN network. As used herein, a composite service is a service deployed across an NGN network that has been enabled to be accessed through multiple, different modalities of access in correspondingly different channels while maintaining the synchronization of the state of the service between the different channels of access.

In a first embodiment of the invention, a speech disambiguation method for use in a composite services enablement environment can include establishing both a voice channel of access and a visual channel of access to a common session in the composite services enablement environment. The method also can include providing a voice view for the voice channel of access in a voice end point, and a visual view for the visual channel of access in a visual end point. The method yet further can include synchronizing the voice and visual views responsive to detecting updates to a model for the session. Finally, the method can include utilizing model updates provided by the visual view when disambiguating voice input in the voice view.

In one aspect of the invention, utilizing model updates provided by the visual view when disambiguating voice input in the voice view can include building a list of N-best candidate words when speech recognizing the voice input and selecting one of the candidate words based upon a model update provided by the visual view. In another aspect of the invention, utilizing model updates provided by the visual view when disambiguating voice input in the voice view can include filtering a set of speech grammars based upon a model update provided by the visual view and applying the filtered set of speech grammars when speech recognizing the voice input.

Another embodiment of the invention can include a composite service enabling data processing system. The system can include a visual channel servlet enabled to establish for a common session a visual channel of access to a composite service, and a voice channel servlet enabled to establish for the common session a voice channel of access to a composite service. The system further can include a model servlet configured for coupling to a model for the common session, for modifying state data in the model for the common session, and to synchronize views for each of the channels of access to the composite service responsive to updates detected in the model. Finally, the system can include speech disambiguation logic coupled to the voice channel servlet.

The speech disambiguation logic can include program code enabled to utilize model updates provided over the visual channel of access when disambiguating voice input in the voice channel of access. For instance, the program code of the speech disambiguation logic can be enabled to build a list of N-best candidate words when speech recognizing voice input, and to select one of the candidate words based upon a model update provided over the visual channel of access. Additionally, a set of speech grammars can be coupled to the voice channel servlet. As such, the speech disambiguation logic further can include program code enabled to filter the set of speech grammars based upon a model update provided over the visual channel of access, and to apply the filtered set of speech grammars when speech recognizing voice input provided over the voice channel of access.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of an IMS configured for use with a data processing system arranged to deploy and deliver composite services in an NGN network;

FIG. 2 is a schematic illustration of a data processing system arranged to deploy and deliver composite services in an NGN network;

FIG. 3 is a flow chart illustrating a process for delivering composite services in an NGN network;

FIG. 4 is a schematic illustration of a composite services enablement environment configured for speech disambiguation; and,

FIGS. 5A and 5B, taken together, are a flow chart illustrating a process for speech disambiguation in the composite services enablement environment of FIG. 4.

### DETAILED DESCRIPTION OF THE INVENTION

Embodiments of the present invention provide a method, system and computer program product for delivering composite services in an NGN network. In accordance with an embodiment of the present invention, different channels of access to a service can be established for accessing a service through corresponding different modalities of access including voice and visual modes. Specifically, interactions with a service within a session can be provided across selected ones of the different channels, each channel corresponding to a different modality of access to the service. In the case of a voice modality and a visual modality, a separate markup document can be utilized in each selected channel according to the particular modality for that channel.

Importantly, each channel utilized for accessing a service within a session can be associated with each other channel accessing the service within the same session. In consequence, the state of the service—stored within a model in a model-view-controller architecture—can be maintained irrespective of the channel used to change the state of the service. Moreover, the representation of the service can be synchronized in each view for the selected ones of the different channels. As such, an end user can interact with the service in a single session across different channels of access using different modalities of access without requiring burdensome, proprietary logic deployed within a client computing device.

In accordance with the present invention, model updates provided by a visual channel of access to a session can be used to disambiguate recognized speech when accepting speech input over a voice channel of access to the session. In this regard, speech input over the voice channel of access can be recognized as one of a possible set of recognized. Updates to the model for the session by the visual channel of access can be used as hints for selecting amongst the recognized words. As such, the updates to the model can provide the necessary context for properly disambiguating the recognized speech. Also, the speech grammars used to perform the recognition of speech over the voice channel of access can be filtered based upon updates to the model provided by the visual channel. In this way, speech recognition in the voice channel of access can be facilitated through input provided over the visual channel of access.

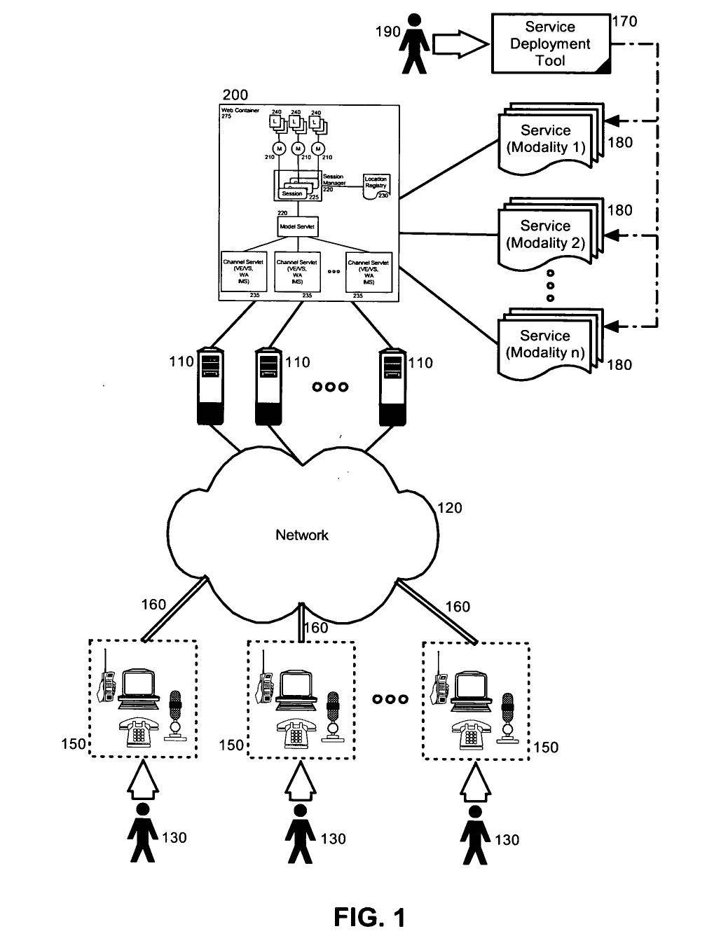

Advantageously, the system of the present invention can be embodied within an IMS in a NGN network. In illustration, FIG. 1 is a pictorial illustration of an IMS configured for use with a data processing system enabled to establish a voice channel of access to a session for a composite service from a visual channel of access to the session in an NGN network. As shown in FIG. 1, a composite service enablement data processing system 200 can be arranged to deploy and deliver a composite multimedia service 180 in an NGN network 120. As used herein, a “composite multimedia service” can be a service configured to be accessed through multiple different views of different modalities across correspondingly different channels of communications.

More specifically, the composite multimedia service 180 can be accessed through several different modalities, including a visual mode, an instant messaging mode and a voice mode. Each modality of access can be produced by a developer 190 through the use of a service deployment tool 170. The service deployment tool 170 can be configured to produce the different modalities of access for the composite multimedia service 180, including visual markup to provide visual access to the composite multimedia service 180, and voice markup to provide audible access to the composite multimedia service 180.

One or more gateway server platforms 110 can be coupled to the composite service enablement data processing system 200. Each of gateway server platforms 110 can facilitate the establishment of a communication channel for accessing the composite multimedia service 180 according to a particular modality of access. For example, the gateway server platforms 110 can include a content server such as a Web server enabled to serve visual markup for accessing the composite multimedia service 180 over the NGN network 120 through a visual mode. Likewise, the gateway server platforms 110 can include a voice server enabled to provide audible access to the composite multimedia service 180 over the NGN network 120 through an audible mode.

End users 130 can access the composite multimedia service 180 utilizing any one of a selection of client access devices 150. Application logic within each of the client access devices 150 can provide an interface for a specific modality of access. Examples include a content browser within a personal computing device, an audible user interface within a pervasive device, a telephonic user interface within a telephone handset, and the like. Importantly, each of the provided modalities of access can utilize a separate one of multiple channels 160 established with a corresponding gateway server platform 110 over the network 120 for the same session with the composite multimedia service 180. In this regard, a session with the composite multimedia service 180 can subsist across the multiple channels 160 to provide different modalities of access to the composite multimedia service 180 for one of the end users 130.

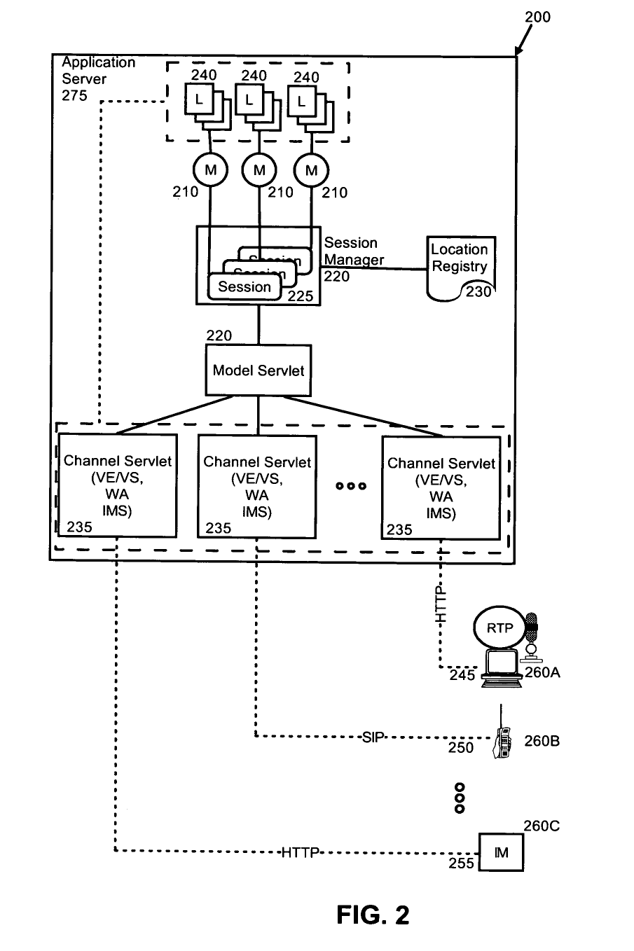

In more particular illustration, FIG. 2 is a schematic illustration of the composite service enablement data processing system 200 of FIG. 1. The composite service enablement data processing system 200 can operate in an application server 275 and can include multiple channel servlets 235 configured to process communicative interactions with corresponding sessions 225 for a composite multimedia service over different channels of access 245, 250, 255 for different endpoint types 260A, 260B, 260C in an NGN network. In this regard, the channel servlets 235 can process voice interactions as a voice enabler and voice server to visual endpoint 260A incorporating a voice interface utilizing the Real Time Protocol (RTP) over HTTP, or a voice endpoint 260B utilizing SIP. Likewise, the channel servlets 235 can process visual interactions as a Web application to a visual endpoint 160A. As yet another example, the channel servlets 235 can process instant message interactions as an instant messaging server to an instant messaging endpoint 260C.

More specifically, the channel servlets 235 can be enabled to process HTTP requests for interactions with a corresponding session 225 for a composite multimedia service. The HTTP requests can originate from a visual mode oriented Web page over a visual channel 245, from a visual mode oriented instant messaging interface over an instant messaging channel 255, or even in a voice mode over a voice channel 250 enabled by SIP. Similarly, the channel servlets 235 can be enabled to process SIP requests for interactions with a corresponding session 225 for a composite multimedia service through a voice enabler which can include suitable voice markup, such as VoiceXML and call control extensible markup language (CCXML) coupled to a SIPlet which, in combination, can be effective in processing voice interactions for the corresponding session 225 for the composite multimedia service, as it is known in the art.

Each of the channel servlets 235 can be coupled to a model servlet 220. The model servlet 220 can mediate interactions with a model 210 for an associated one of the sessions 225. Each of the sessions 225 can be managed within a session manager 220 which can correlate different channels of communication established through the channel servlets 235 with a single corresponding one of the sessions 225. The correlation of the different channels of communication can be facilitated through the use of a coupled location registry 230. The location registry 230 can include a table indicating a host name of systems and channels active for the corresponding one of the sessions 225.

The model servlet 215 can include program code enabled to access a model 210 for a corresponding session 225 for a composite multimedia service providing different channels of access 245. 250, 255 through different endpoints 260A, 260B, 260C. For instance, the model 210 can be encapsulated within an entity bean within a bean container. Moreover, the model 210 can store session data for a corresponding one of the sessions 225 irrespective of the channel of access 245, 250, 255 through which the session data for the corresponding one of the sessions 225 is created, removed or modified.

Notably, changes in state for each of the sessions 225 for a composite multimedia service can be synchronized across the different views 260 for the different channels of access 245, 250, 255 through a listener architecture. The listener architecture can include one or more listeners 240 for each model 210. Each listener can correspond to a different channel of access 245, 250, 255 and can detect changes in state for the model 210. Responsive to detecting changes in state for the model 210 for a corresponding one of the sessions 225 for a composite multimedia service, a listener 240 can provide a notification to subscribing view 260 through a corresponding one of the channel servlets 235 so as to permit the subscribing views 260 to refresh to incorporate the detected changes in state for the model 210.

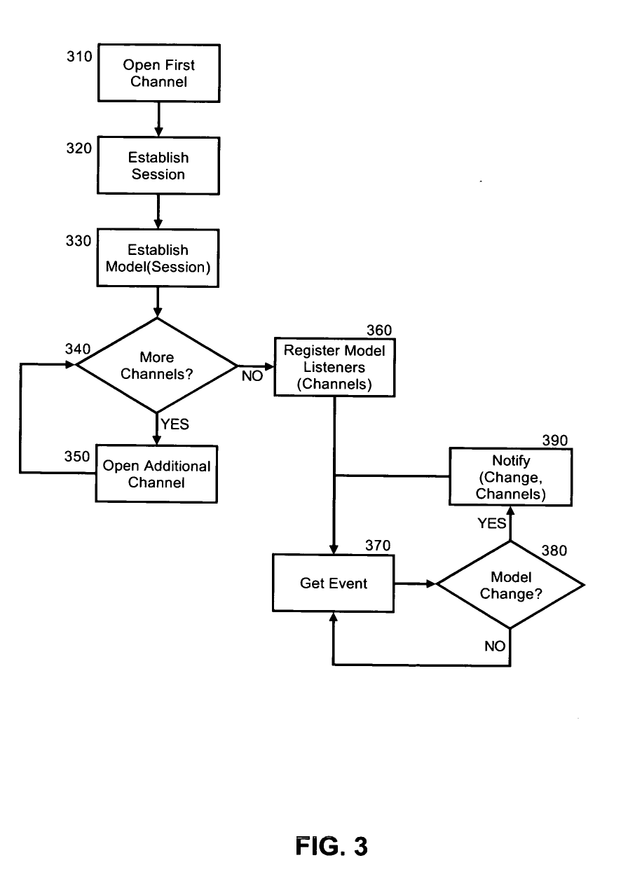

FIG. 3 is a flow chart illustrating a process for managing multiple channels of access to a single session for a composite service in the data processing system of FIG. 2. Beginning in block 310, a first channel of access can be opened for the composite multimedia service and a session can be established in block 320 with the composite multimedia service. Data for the session can be stored in a model for the session which can be established in block 330. If additional channels of access are to be established for the session in decision block 340, the process can continue in block 350. In block 350, an additional channel of access can be established for the same session for as many additional channels as required.

When no further channels of access are to be established in decision block 340, in block 360 a listener can be registered for each established channel of access for the session. Subsequently, in block 370 events can be received in each listener. In decision block 380, when a model change is detected, in block 390, the model change can be provided to each endpoint for selected ones of the established channels of access. In consequence, the endpoints can receive and apply the changes to corresponding views for the selected ones of the established channels of access for the same session, irrespective of the particular channel of access through which the changes to the model had been applied.

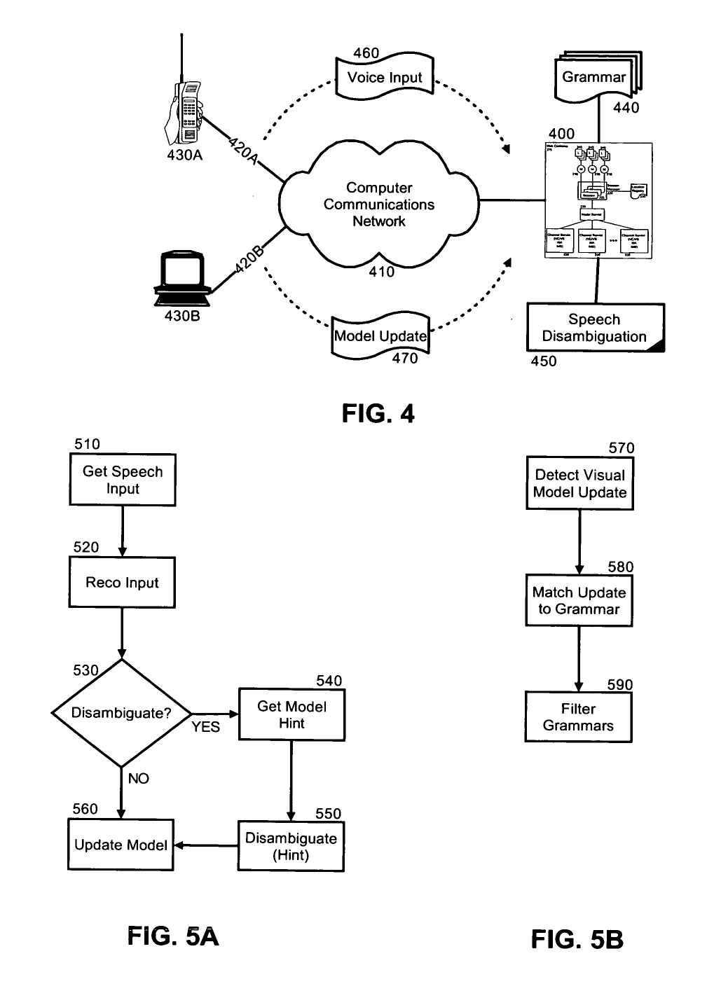

Notably, model updates provided by a visual channel of access to a session can be used to disambiguate recognized speech when accepting speech input over a voice channel of access to the session. In illustration, FIG. 4 is a schematic illustration of a composite services enablement environment configured for speech disambiguation. As shown in FIG. 4, a composite services enablement data processing system 400 can include a set of speech grammars 440 coupled to a voice channel servlet for use in processing speech recognition for voice input 460 provided by a voice end point 430A for a voice channel of access 420 over a computer communications network 410.

The composite services enablement data processing system 400 further can include speech disambiguation logic 450. The speech disambiguation logic 450 can include program code enabled to utilize for speech disambiguation model updates 470 provided by a visual end point 430B for a visual channel of access 420B to the session over the computer communications network 410. Specifically, the speech disambiguation logic 450 can match data in a model update 470 to select from among a set of N-best word candidates produced during speech recognition for voice input 460. Also, a set of grammars 440 used for speech recognition can be filtered based upon the model update 470. For instance, where a model update provides a name of a state such as “Florida”, a grammar for the cities in the State of Florida can be selected while grammars for other cities can be discarded when recognizing voice input for a city name.

In further illustration, FIGS. 5A and 5B, taken together, are a flow chart illustrating a process for speech disambiguation in the composite services enablement environment of FIG. 4. Considering FIG. 5A, in block 510, speech input can be received in a voice channel servlet for a voice channel of access to a session. In block 520 the speech input can be speech recognized to produce a set of N-best word candidates as it is well-known in the art. In decision block 530, it can be determined whether disambiguation is required to select a word among the candidates. If so, in block 540, a hint can be obtained from the model for the session as provided over a visual channel of access to the session. Utilizing the hint, in block 550, a word among the set of N-best word candidates can be selected as the speech recognized word and in block 560 the model can be updated with the speech recognized speech input.

Turning now to FIG. 5B, disambiguation can be performed not only in the course of speech recognizing voice input, but also prior to speech recognition through the filtering of speech grammars used to perform speech recognition. In this regard, in block 570, an update to the model for the session can be received over the visual channel of access to the session. In block 580, the update to the model can be matched to a particular grammar in the set of speech grammars. Alternatively, the update to the model can be used to prune the grammar by eliminating words in the grammar which are not consistent with the update to the model. Subsequently, in block 590, the remaining grammars can be filtered from use during speech recognition of voice input provided over the voice channel of access to the session. In this way, model updates provided by the visual channel of access to the session can be used to disambiguate speech input provided over the voice channel of access to the session. Notably, updates to the model provided through the visual channel of access to the session can be used during speech recognition to prune the search trees used by the speech recognition engine to speech recognize voice input provided through the voice channel of access to the session

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A speech disambiguation method for use in a composite services enablement environment, the method comprising:
establishing both a voice channel of access and a visual channel of access to a common session in the composite services enablement environment;
providing a voice view for the voice channel of access in a voice end point, and a visual view for the visual channel of access in a visual end point;
synchronizing the voice and visual views responsive to detecting updates to a model for the session; and,
utilizing model updates provided by the visual view when disambiguating voice input in the voice view.

2. The method of claim 1, wherein synchronizing the voice and visual views responsive to detecting updates to a model for the session, comprises:
maintaining the state of the model for the session;
creating listeners for changes of the state for the model;
detecting changes in the state for the model in the listeners; and,
updating the voice and visual views responsive to detecting the changes of state for the model in the listeners.

3. The method of claim 1, wherein utilizing model updates provided by the visual view when disambiguating voice input in the voice view, comprises:
building a list of N-best candidate words when speech recognizing the voice input; and,
selecting one of the candidate words based upon a model update provided by the visual view.

4. The method of claim 1, wherein utilizing model updates provided by the visual view when disambiguating voice input in the voice view, comprises:
filtering a set of speech grammars based upon a model update provided by the visual view; and,
applying the filtered set of speech grammars when speech recognizing the voice input.

5. A composite service enabling data processing system comprising:
a visual channel servlet enabled to establish for a common session a visual channel of access to a composite service;
a voice channel servlet enabled to establish for the common session a voice channel of access to a composite service;
a model servlet configured for coupling to a model for the common session, for modifying state data in the model for the common session, and to synchronize views for each of the channels of access to the composite service responsive to updates detected in the model; and,
speech disambiguation logic coupled to the voice channel servlet, the speech disambiguation logic comprising program code enabled to utilize model updates provided over the visual channel of access when disambiguating voice input in the voice channel of access.

6. The system of claim 5, wherein the program code of the speech disambiguation logic is enabled to build a list of N-best candidate words when speech recognizing voice input, and to select one of the candidate words based upon a model update provided over the visual channel of access.

7. The system of claim 5, further comprising a set of speech grammars coupled to the voice channel servlet, the speech disambiguation logic further comprising program code enabled to filter the set of speech grammars based upon a model update provided over the visual channel of access, and to apply the filtered set of speech grammars when speech recognizing voice input provided over the voice channel of access.

8. The system of claim 5, wherein the voice channel servlet comprises a voice enabler and voice server enabled to establish for the single session, the voice channel of access to the composite service.

9. The system of claim 5, wherein the channel servlets and model servlet are disposed in a Web container.

10. The system of claim 5, wherein the channel servlets and model servlet are disposed in an Internet protocol (IP) multimedia subsystem (IMS) in a next generation networking (NGN) network.

11. A computer program product comprising a computer usable medium having computer usable program code for speech disambiguation in a composite services enablement environment, the computer program product including:
computer usable program code for establishing both a voice channel of access and a visual channel of access to a common session in the composite services enablement environment;
computer usable program code for providing a voice view for the voice channel of access in a voice end point, and a visual view for the visual channel of access in a visual end point;
computer usable program code for synchronizing the voice and visual views responsive to detecting updates to a model for the session; and,
computer usable program code for utilizing model updates provided by the visual view when disambiguating voice input in the voice view.

12. The computer program product of claim 11, wherein the computer usable program code for synchronizing the voice and visual views responsive to detecting updates to a model for the session, comprises:
computer usable program code for maintaining the state of the model for the session;
computer usable program code for creating listeners for changes of the state for the model;
computer usable program code for detecting changes in the state for the model in the listeners; and,
computer usable program code for updating the voice and visual views responsive to detecting the changes of state for the model in the listeners.

13. The computer program product of claim 11, wherein the computer usable program code for utilizing model updates provided by the visual view when disambiguating voice input in the voice view, comprises:
computer usable program code for building a list of N-best candidate words when speech recognizing the voice input; and,
computer usable program code for selecting one of the candidate words based upon a model update provided by the visual view.

14. The computer program product of claim 11, wherein the computer usable program code for utilizing model updates provided by the visual view when disambiguating voice input in the voice view, comprises:
computer usable program code for filtering a set of speech grammars based upon a model update provided by the visual view; and,
computer usable program code for applying the filtered set of speech grammars when speech recognizing the voice input.
